(19) United States
(12) Patent Application Publication
(10) Pub. No.: US 2009/0067951 A1
(43) Pub. Date: Mar. 12, 2009

(54) Bookbinding Unit, Bookbinding Method and Image-Forming System

(75) Inventors: Takehiro Yamakawa, Minamitsuru-gun (JP); Hiroyuki Sorita, Chuo-shi (JP); Jun Kondou, Minami-Alps-shi (JP); Katsumasa Takagi, Kofu-shi (JP); Takeshi Harada, Nakakoma-gun (JP)

Correspondence Address: Judge Patent Associates, Dojima Building, 5th Floor, 6-8 Nishitemma 2-Chome, Kita-ku, Osaka-Shi, 530-0047, JP

(73) Assignee: Nisca Corporation, Yamanashi-ken (JP)

(21) Appl. No.: 12/209,201

(22) Filed: Sep. 11, 2008

(30) Foreign Application Priority Data
Sep. 11, 2007 (JP) 2007-235952

(51) Int. Cl. B42C 9/00; G03G 21/16

(52) U.S. Cl. 412/37; 399/111

(57) ABSTRACT

Affords a bookbinding method and bookbinding unit that attach the bookmarker string when binding inner-bound sheets coated with adhesive on the spine portion to the spine portion of the coversheet. Apply adhesive to a spine portion of inner-bound sheets collated and stacked into a bundle, join that sheet bundle to a spine portion of a coversheet, and fold the coversheet over the sheet bundle. At that time, the bookmarker string is attached to the booklet simultaneously by joining the sheet bundle to the coversheet with the bookmarker string placed over the inside spine portion of the coversheet.

### BACKGROUND OF THE INVENTION

1. Technical Field

The present invention—involving bookbinding methods and bookbinding devices that collate and stack into bundles sheets conveyed out from an image-forming system or other source, and encase such inner-bound sheet bundles in a coversheet to create a booklet—relates to improvements in methods and apparatuses for incorporating bound bookmarks into booklets during their formation.

2. Description of the Related Art

Generally, this type of bookbinding device collates and stacks into bundles on a stacking tray sheets conveyed from an image-forming system, and coats the spine portion of the sheet bundles with an adhesive. At the same time, a coversheet is fed from an inserter unit (feeder unit), disposed upstream of the image-forming system or stacking tray, to a coversheet binding location situated downstream of the adhesive application location. Encasing bookbinding devices that then, in the coversheet binding location, join the adhesive-coated sheet bundle, in an inverted T, to the coversheet along its central portion (spine-binding portion) and afterwards spine-crease the coversheet to finish it into form are known.

Japanese Unexamined Pat. App. Pub. No. 2007-76118 (FIG. 1), for example, discloses a conventional bookbinding device of this sort. In this publication, the bookbinding device is set up linked to the discharge outlet of an image-forming system, from which printed sheets are stacked on the unit's stacking tray. Then after adhesive has been applied to the spine portion of a sheet block having been collated into bundle form, the block is transported to a downstream coversheet binding location. Therein, a coversheet supply path is provided ranging to the coversheet binding location, with the bookbinding device being configured to feed coversheets through the coversheet supply path to the coversheet binding location.

In bookbinding devices such as just described, the attaching in of a bookmarker string during the coversheet binding process has not been known to date. That is, with conventional bookmarker strings, as disclosed, for example, in Japanese Unexamined Pat. App. Pub. Nos. 10-297138 and 10-297139, a gap into which the string is later attached is formed in between the inner-bound sheets and the coversheet. Bookbinding methods are known whereby, after the three sides of a cover-binding processed sheet bundle have been trimmed true (have been trim-cut), an end of the bookmarker string is then inserted into the gap and fixed in place with an adhesive.

In implementations as just described, in which booklets are formed by encasing inner-bound sheets in a coversheet, the bookmarker string is inserted at one end into the spine-cover portion of the booklet after the bookbinding process and anchored with an adhesive. Problems with the conventional method of in this way post-attaching the bookmarker string after the coversheet binding process are that it requires an operational step in order to glue in the bookmarker string, and that operation is unavoidably a hands-on job.

In particular, in bookbinding device implementations in which sheets are conveyed out from an image-forming system or other source, and are collated and stacked and in succession encased in a coversheet, forming a gap along the spine-binding area for insertion of a bookmarker string is problematic. This difficulty has been prohibitive of automatically executing the series of steps in the covering operation, in which, typically, an adhesive is applied to the spine-portion endface of an inner-bound sheet bundle, a gap is created for post-attaching a bookmarker string when the sheet bundle is joined to the coversheet, and further one end of the bookmarker string is inserted into the gap and anchored with an adhesive or the like.

### BRIEF SUMMARY OF THE INVENTION

Therein, the inventors came upon the idea of overlaying the bookmarker string over the coversheet and gluing (binding) the three pieces (sheet bundle, bookmarker string and coversheet) together by joining the sheet bundle coated with adhesive at the spine portion of the coversheet, then folding the coversheet over the sheet bundle thereafter. This eliminates the need for the work to attach the bookmarker string later, and eliminates the need to establish an unglued area at the spine portion for the later-attachment of the bookmarker string.

The present invention provides a bookbinding method and bookbinding unit for attaching a bookmarker string when binding inner-bound sheets coated with adhesive on the spine portion to the spine portion of the coversheet.

Still further, the present invention provides an image-forming system that attaches the bookmarker string at low cost using a simple method to collate and stack printed sheets and create a booklet by encasing them in a coversheet.

In order to attain the aforementioned objects, the present invention creates a booklet by applying adhesive to a spine portion of inner-bound sheets collated and stacked into a bundle, joining that sheet bundle to a spine portion of a coversheet, and folding the coversheet over the sheet bundle. A feature of the present invention is to simultaneously attach a bookmarker string to the booklet by joining the sheet bundle to the coversheet with the bookmarker string placed over the inside spine portion of the coversheet. The configuration will now be explained.

A bookbinding unit equipped with a processing stage for encasing in a coversheet inner-bound sheets collated into a sheet bundle comprises adhesive layer forming means for coating a spine portion of the sheet bundle with an adhesive layer; coversheet feeding means for feeding a coversheet to the processing stage; coversheet binding means that has a bookmarker string supply means for feeding and placing a bookmarker string over the coversheet conveyed to the processing stage upstream thereof, and for folding the coversheet over the sheet bundle; control means for controlling the coversheet feeding means, the bookmarker string supply means, and the coversheet binding means is disposed in the processing stage.

The control means (1) supplies a coversheet to the processing stage; (2) supplies bookmarker string to the overlay the coversheet at the processing stage; and (3) joins the bookmarker string, the sheet bundle and the coversheet, then folds the coversheet to form shoulders on the booklet.

The bookmarker string supply means is composed of a bookmarker-string storage unit, and a feeder means for feeding bookmarker string from the bookmarker-string storage unit to the spine portion of the coversheet, and is composed to store a continuous roll of string or predetermined length of a string bundle in the bookmarker-string storage unit.

The bookmarker string supply means is composed of a bookmarker base material such as cloth or resin film and the like; forming means for punching out bookmarker string of a predetermined shape from the bookmarker base material; and feeder means for feeding the bookmarker string from the forming means to the spine portion of the coversheet.

Trimming means for trimming true edges of a covered sheet bundle is provided downstream of the processing stage; the trimming means cuts ends of the bookmarker string when trimming the sheet bundle.

Also, the image-forming system according to the present invention is composed of an image-forming unit that sequentially forms images on sheets, and a bookbinding unit that collates into sheet bundles sheets conveyed from the image-forming unit and encases the sheet bundles in a coversheet; the bookbinding unit is composed as described above.

A method for bookbinding by encasing in a coversheet sheets collated into a sheet bundle, comprises a coversheet feeding step that conveys a coversheet to a predetermined coversheet binding location; a bookmarker string setting step that places a bookmarker string over a predetermined position on the coversheet conveyed to the coversheet binding location; an adhesive layer forming step that applies a layer of adhesive on a spine portion of inner-bound sheets collated into a bundle shape; and a coversheet binding step that binds the inner-bound sheets of the sheet bundle to the coversheet overlapped with the bookmarker string.

The bookmarker string setting step positions an end of the bookmarker string at a position of the spine position of the coversheet and the other end to overlap the coversheet to be positioned on the inner surface of the coversheet.

The present invention achieves the following effects because the bookmarker string is placed over the coversheet and glued simultaneously when the inner-bound sheets (the sheet bundle) coated with adhesive on the spine portion are bound to the spine portion of the coversheet.

The bookmarker string is set over the coversheet so that an end is positioned at the spine portion of the coversheet, and in that state the spine portion of the inner-bound sheets that is coated with adhesive is joined to the coversheet, so there is no need for a special process or complex work to attach the bookmarker string. Particularly, compared to the conventional method of attaching the bookmarker string to the spine portion after binding the sheet bundle to the coversheet, the present invention does not require any later process to attach the bookmarker. The bookmarker string can be attached at the same time as the bookbinding process. Therefore, the attachment work of the bookmarker string is less expensive and easier.

Also, for a configuration to attach the bookmarker string in the bookbinding unit, it is acceptable to provide only feeder means to feed and place the bookmarker string over the coversheet when the coversheet is set at the coversheet binding stage. This provides a low-cost and simple structure.

### BRIEF DESCRIPTION OF THE SEVERAL VIEWS OF THE DRAWINGS

FIG. 1 shows the overall configuration of an image forming system equipped with the bookbinding unit of the present invention;

FIG. 2 is a detailed view of the bookbinding unit shown in FIG. 1;

FIG. 3 illustrates an adhesive application means in the apparatus shown in FIG. 2, wherein FIG. 3A shows an overall configuration of an adhesive container, and FIG. 3B is an explanatory view of the application of adhesive;

FIG. 4A is an explanatory view of the configuration of a processing stage, and 4B is a configuration diagram of a sliding member;

FIG. 5 is explanatory views showing a configuration of a bookmarker string supply means in the apparatus shown in FIG. 2, wherein FIG. 5A shows an initial state, and FIG. 5B is a state diagram showing the bookmarker string pulled in the X-X direction;

FIG. 6 is explanatory views of operations showing an action of the bookmarker string supply means of FIG. 5, wherein FIG. 6A shows the bookmarker string shifted in a Y-Y direction, and FIG. 6B shows a trailing end of the bookmarker string cut;

FIG. 7 illustrates a bookmarker string supply means that is different from the one shown in FIG. 5, wherein FIG. 7A is a perspective view, and FIG. 7B is an overall configuration diagram;

FIG. 8 is a block schematic view of a configuration of control means in the apparatus shown in FIG. 2; and

FIG. 9 is a flowchart for the bookbinding method of the apparatus of FIG. 2.

### DETAILED DESCRIPTION OF THE INVENTION

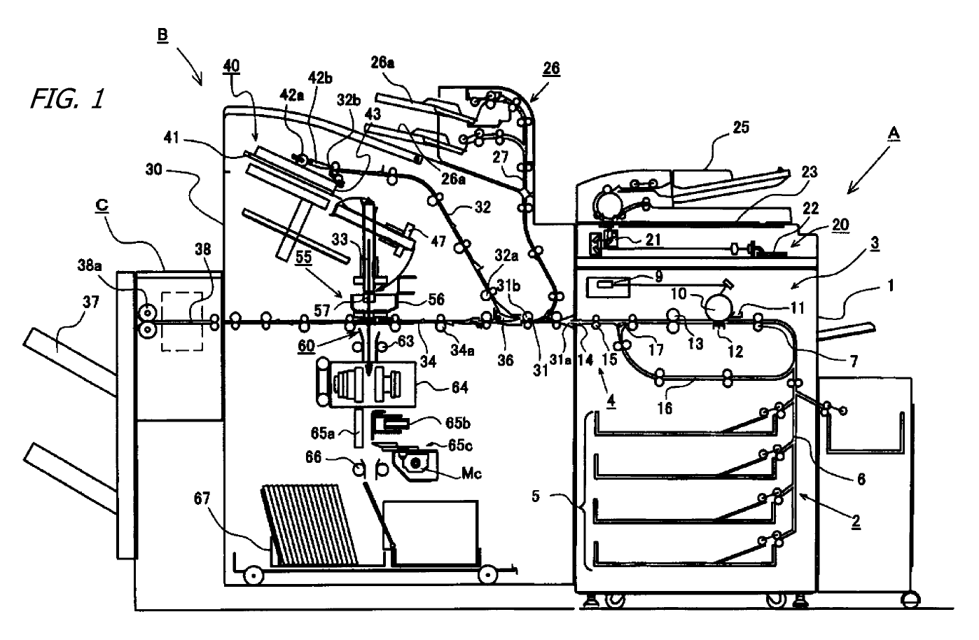

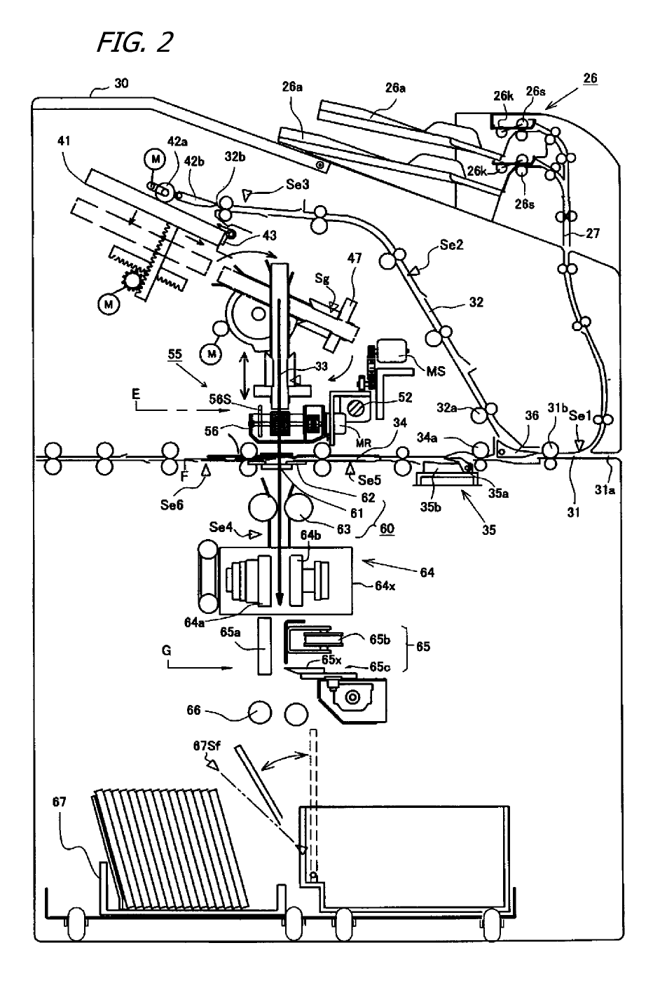

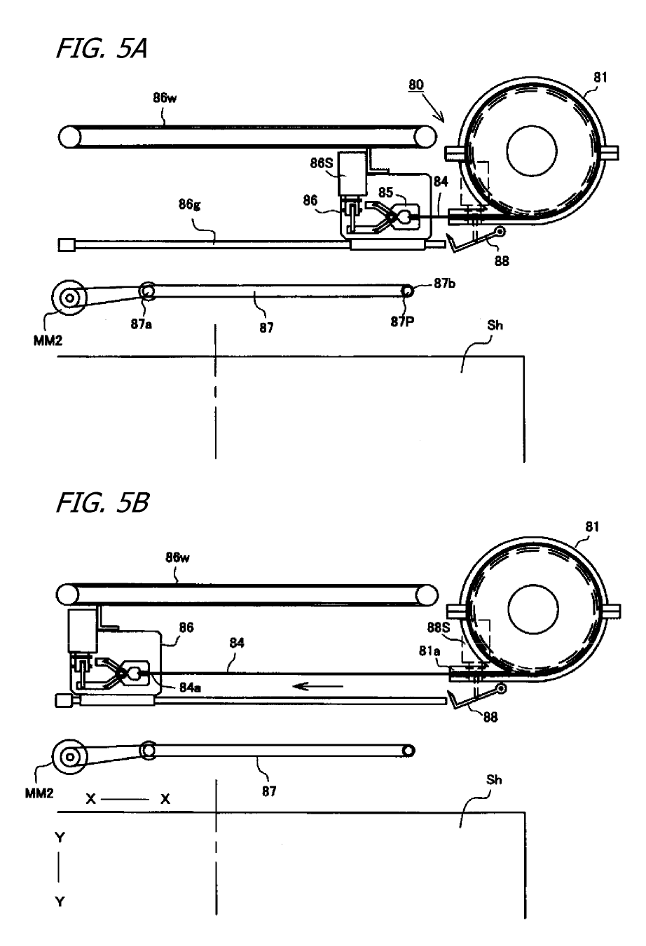

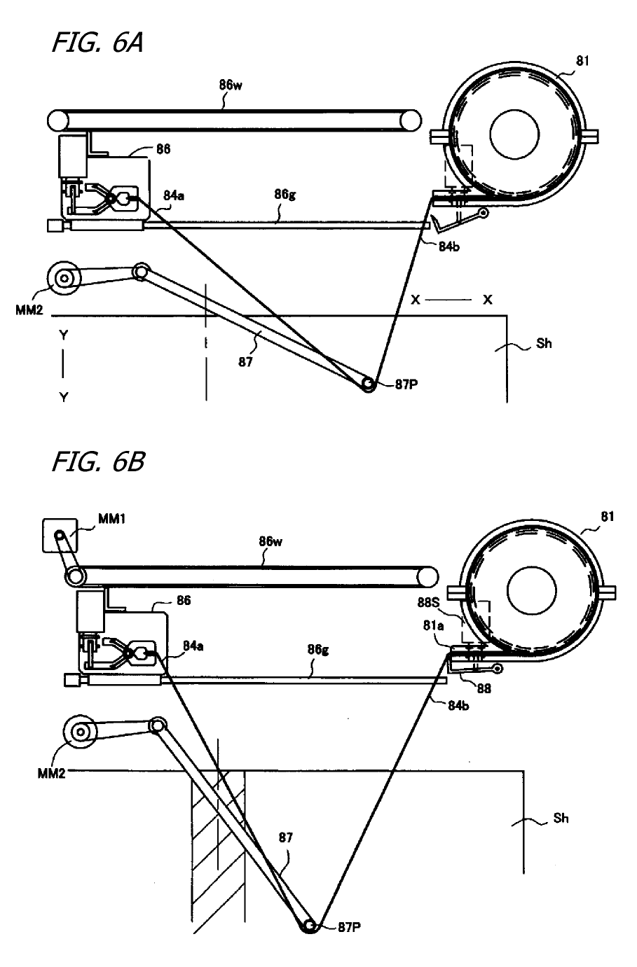

A preferred embodiment of the present invention will now be explained based on the drawings provided. FIG. 1 is an explanatory view of the bookbinding apparatus according to the present invention and the overall configuration of the image-forming system that uses the bookbinding apparatus; FIG. 2 is a detailed explanatory view of the bookbinding apparatus. FIG. 5 is an expanded explanatory view of the essential portion of FIG. 2, and shows a coversheet supply path. FIGS. 6A and 6B are explanatory views of the conveyance state of the coversheet.

As shown in FIG. 1, an image-forming system according to the present invention is composed of an image-forming unit A that sequentially forms images on sheets; and a bookbinding unit B linked to a discharge outlet 14 of the image-forming unit A, that collates sheets formed with images into a sheet bundle, binds the sheet bundle, then trims true the edges of the bound sheet bundle. A finisher unit C is provided in the apparatus shown in FIG. 1 downstream of the bookbinding unit B. The following will now describe the configuration of each unit in detail.

### Configuration of the Image-Forming Unit

As shown in FIG. 1, the image-forming unit A can adopt a variety of structures of a copier, printer or printing machine. The drawing shows an electrostatic printing system. A sheet feeder 2, a printing unit 3, a discharge unit 4 and a control unit are installed inside the casing 1 on the image-forming unit A. A plurality of cassettes 5 that correspond to sheet sizes is prepared at the sheet feeder 2. Sheet sizes specified by the control unit are fed to the sheet feeding path 6. A registration roller 7 is equipped at the sheet feed path 6. After the leading edge of the sheet is registered by this roller, the sheet is fed at a predetermined timing to the downstream printing unit.

A static electric drum 10 is equipped at the printing unit 3. A print head 9, a developer 11 and a transfer charger 12 are disposed around this drum 10. The print head 9 is composed of a laser emitter, for example, to form electrostatic latent images on the electrostatic drum 10. Toner ink adheres to the latent image at the developer 11, and this is transferred and printed on the sheet at the transfer charger 12. The printed sheet is the fixed at the fixer 13 and discharged to the discharge path 17. A discharge outlet 14 formed in the casing 1 and a discharge roller 15 are disposed at the discharge unit 4. Note that 16 is a cycling path. Printed sheets from the discharge path 17 are turned over from front to back at a switchback path, then fed again to the registration roller 7 so that images can be formed on the backside of the printed sheet. In this way, a sheet formed with images on one side or both sides is conveyed from the discharge outlet 14 by the discharge roller 15.

Note that the symbol 20 in the drawings denotes a scanner unit. This optically reads images on an original to printed using the print head 9. The structure is generally known to be composed of a platen 23 where an original sheet is placed; a scanning carriage 21 that travels along the platen 23 to scan the original image; and an optical reading means (such as a CCD device) that photo-electrically converts the optical image from the carriage 21. The drawing shows an original feeding apparatus 25 that automatically feeds the original sheet to the platen, installed over the platen 23.

### Bookbinding Unit Configuration

The following will now explain the bookbinding unit B that is attached to the image-forming unit A. The bookbinding unit B is composed of a stacker 40 that stacks and collates printed sheets into bundles; an adhesive applicator means 55 that applies adhesive to the sheet bundle conveyed from the stacker 40; and coversheet binding means 60 that binds the coversheet to the sheet bundle applied with adhesive, in the casing 30.

### Configurations of the Conveyance Paths

A conveyance path 31 having a conveyance inlet 31a linked to the discharge outlet 14 of the image-forming unit A is provided in the casing 30, and the intermediate sheet conveyance path 32 and coversheet conveyance path 34 are linked from this conveyance path 31 via the path switching flapper 36. The bookbinding path 33 is linked to the coversheet conveyance path 34 via the stacker 40, and a finishing path 38 is connected to the coversheet conveyance path 34. The bookbinding path 33 is disposed to traverse the apparatus longitudinally in a substantially longitudinal direction, and the coversheet conveyance path 34 is disposed in a direction to traverse the apparatus in a lateral direction.

The bookbinding path 33 and the coversheet conveyance path 34 mutually intersect (orthogonally); a processing stage (coversheet binding location) F, described below, is disposed in the intersection. The conveyance path 31 configured as described above is linked to the discharge outlet 14 of the image-forming unit A to receive printed sheets from the image-forming unit A. Sheets printed (the inner sheets) with content information and a sheet (hereinafter referred to as a coversheet) printed with a title for use as the coversheet are conveyed out from the image-forming unit A. This conveyance path 31 is branched into the intermediate sheet conveyance path 32 and the coversheet conveyance path 34, and sort printed sheets to convey them into each path by the use of a path switching flapper 36.

In contrast, an inserter unit 26 is connected to the conveyance in path 31. This is configured to separate one coversheet at a time that will not be printed at the image-forming unit A from the feeder tray 26a and feed the coversheet to the conveyance in path 31. A kick roller 26k and separating means 26s are disposed in the feeder tray 26a; the kick roller 26k feeds sheets on the tray, and the separating means separates them into single sheets and conveys them further downstream. Also, a sheet feeding path 27 is provided downstream of the separating means 26s to link to the conveyance path 31.

The conveyance roller 31b is disposed in the convey-in path 31; the conveyance roller 32a is disposed in the inner-sheet conveyance path 32; the gripping conveyance means 47, the bundle posture changing means 64, described below, and the discharge roller (discharge means) 66 are disposed in the bookbinding path 33. A conveyance roller 34a is disposed in the coversheet conveyance path 34 and a conveyance roller 38a is disposed in a finishing path 38; these rollers are connected to a drive motor.

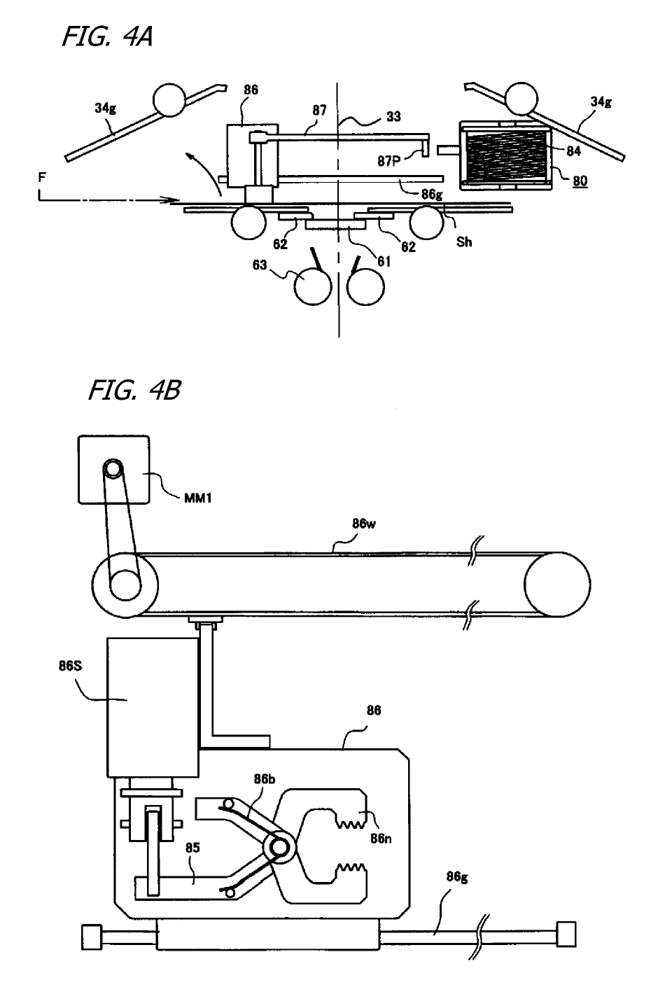

The following will now explain the configuration of the coversheet conveyance path 34 based on FIGS. 1 and 2. The coversheet conveyance path 34 branches from the conveyance path 31 and intersects the bookbinding path 33. The processing stage (coversheet binding location) F is disposed in that intersection. The conveyance roller 34a that conveys the coversheet Sh and an aligning mechanism 35 are disposed in the bookbinding path 33. A path guide that forms the coversheet conveyance path 34 is composed of a movable guide 34g that moves up and down between a guiding orientation and a retreated orientation upstream and downstream of the processing stage F. This guide is positioned in the guiding orientation (see the state shown in FIG. 2) to guide the coversheet Sh to the processing stage F, and is shifted to the retreated orientation (see the state shown in FIG. 4A) when the coversheet Sh is being folded.

The aligning mechanism 35 is composed of nipping claw 35a that engages a trailing edge of the coversheet Sh, an aligning member 35b that offsets in a direction perpendicular to the direction of conveyance the coversheet Sh gripped by the nipping claw, and a forward and reverse drive roller (not shown) that switches back the coversheet Sh conveyed in the coversheet conveyance path 34 to abut the nipping claw 35a, provided in the coversheet conveyance path 34. The forward and reverse drive roller is composed to move up and down with regard to its retreated idle position above the coversheet Sh.

Therefore, the coversheet Sh conveyed into the coversheet conveyance path 34 is switched back and conveyed by the reverse drive of the forward and reverse drive roller at a predetermined timing after its trailing edge passes the aligning mechanism 35. Then, the trailing edge of the sheet abuts the nipping claw 35a which corrects any skewing of the sheet. In this state the nipping claw 35a grips the trailing edge of the sheet and the aligning member 35b equipped with this nipping claw 35a moves in a direction perpendicular to the direction of sheet conveyance to align the sides of the sheet. This corrects any skewing the coversheet Sh may have in the leading and trailing edge directions of sheet conveyance, and the position of the sheet in its width direction (a direction perpendicular to the direction of sheet conveyance) (in other words correction of the side edge positions). The coversheet Sh that has been aligned is conveyed toward the downstream processing stage F by the forward and reverse drive rollers. Conveying and setting the sheet at the processing stage F is performed by conveying the coversheet from the aligning position a predetermined amount.

### Stacker Configuration

The stacking tray 44 arranged at the discharge outlet 32b of the intermediate sheet conveyance path 32 stacks and stores sheets from the discharge outlet 32b in a bundle. As shown in FIG. 2, the stacking tray 44 is composed of a tray member disposed in substantially horizontal posture; a forward and reverse rotating roller 42a and conveyance guide 42b are furnished thereabove. Also, printed sheets from the discharge outlet 32b are guided to the stacking tray 41 by the conveyance guide 42b and are stored by the forward and reverse rotating roller 42a. The forward and reverse rotating roller 42a feeds the printed sheet to the leading edge of the stacking tray 41 with a forward rotation. When rotated in reverse, the trailing edge of the sheet is pushed against an aligning member 43 disposed at the trailing edge of the tray (the right edge of FIG. 2) to become aligned. A sheet side aligning means, not shown, is equipped on the stacking tray 41 to align both edges of the printed sheet stored in the tray to reference positions. With this configuration, printed sheets conveyed from the inner-sheet conveyance path 32 are sequentially stacked in the stacking tray 41 and aligned into a bundle shape.

Sheet bundle thickness identifying means, not shown, is disposed in the stacking tray 41 to detect the thickness of the sheet bundle stacked in the tray. It is possible to identify the thickness of the sheet bundle with that configuration by providing a paper touching piece that touches the uppermost sheet on the tray and detecting the position of that paper touching piece using a sensor. As another sheet thickness identification means, it is possible to detect the thickness of a sheet bundle by detecting the sheets conveyed out to the stacking tray using a discharge sensor Se3, and using a counter to count the signals from that sensor. The total number of sheets calculated when the job end signal is issued is then multiplied by the average thickness of a sheet of paper to identify the thickness of the sheet bundle.

### Configuration of Sheet Bundle Conveyance Means

Gripping conveyance means 47 are furnished in the bookbinding path 33 to convey a sheet from the stacking tray 41 to a downstream adhesive application location E. As shown in FIG. 2, the gripping conveyance means 47 turns the sheet bundle stacked on the stacking tray 41 from a horizontal posture to a vertical posture, then conveys the sheet bundle to the adhesive application location E by conveying it along the bookbinding path 33 disposed in a substantially vertical direction. For that reason, the stacking tray 41 moves from a stacking position (solid lines in FIG. 2) to the hand-over position (dashed line in FIG. 2), and hands over the sheet bundle to the gripping conveyance means 47 prepared at this hand-over position.

### Configuration of Adhesive Application Unit

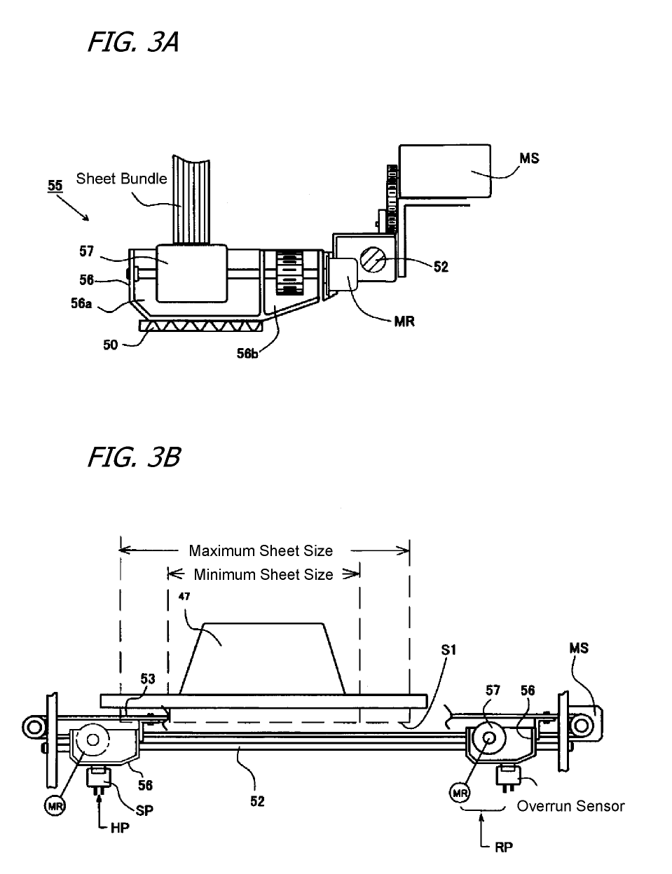

An adhesive application means 55 is disposed in the adhesive application location E of the bookbinding path 33. As shown in FIG. 3A the adhesive application means 55 is composed of an adhesive container 56 that stores hot-melt adhesive; an applicator roller 57; and a roller rotating motor MR. The adhesive container 56 is separated into a liquid-form adhesive storage unit (hereinafter referred to as the liquid adhesive storage unit) 56a and a solid-form adhesive storage container (hereinafter referred to as the solid adhesive storage unit) 56b; an applicator roller 57 is rotatably installed in the liquid adhesive storage unit 56a. An adhesive sensor 56S (see FIG. 2) that detects the remaining amount of adhesive is disposed in the liquid adhesive storage unit 56a. The adhesive sensor 56S also acts as an adhesive temperature sensor. At the same time that this sensor detects the temperature of the liquefied adhesive in the liquid adhesive storage unit 56a, it also detects the amount of adhesive remaining in the container according to the difference in temperature of the portion dipped in the adhesive. Also, heating means 50, such as an electric heater or the like, is embedded in the adhesive container 56. This adhesive sensor 56S and heating means 50 are connected to a control CPU 75, described below, to adjust the temperature of the adhesive in the liquid adhesive storage unit 56a to a predetermined temperature for liquefaction in the compartment. The applicator roll 57 is composed of a porous and heat resistant material and is configured to be impregnated with adhesive and to enable adhesive to form a layer on the circumference of the applicator roller.

The adhesive container 56 as described above has a reciprocating motion along the sheet bundle. FIG. 3B is a conceptual view of the container. The adhesive container 56 is formed to a shorter length (dimension) than the bottom edge of the sheet bundle (the backside covered at the binding process) S1. The container is supported on a guide rail 52 of the apparatus frame to move along the bottom edge S1 of the sheet bundle along with the applicator roller 57 installed in that container. The adhesive container 56 is connected to a timing belt 53 installed on the apparatus frame; a drive motor MS is connected to the timing belt 53.

Therefore, drive motor MS reciprocates the adhesive container 56 between a home position HP and a return position RP where the return operation is started along the sheet bundle. Each position is set to the positional relationships shown in FIG. 3B; the return position RP is set based on sheet width size information. The adhesive container 50 is set to the home position HP when the power is turned on (at device initialization). For example, this moves from the home position HP to the return position RP after a predetermined amount of time after a sheet grip signal from the grip sensor Sg provided on the gripping conveyance means 47. At the same time as this movement, the roller rotating motor MR starts rotating the applicator roll 57. Note that the home position sensor of the adhesive container 56 is denoted by the symbol SP in the drawing. With the adhesive applicator means 55 configured as described above, rotation of the drive motor MS starts moving the adhesive container 56 from the left side of FIG. 3B to the right side along the guide rail 52. The amount of travel of the gripping conveyance means 47 is adjusted by the elevator motor (not shown) so that the applicator roller 57 pressingly contacts the sheet bundle to slightly separate the edges of the sheets in the advancing path, and forms a predetermined gap with the sheet bundle edge in the return path to return from the return position RP to the home position HP to apply adhesive.

### Configuration of Coversheet Binding Means

The coversheet binding means 60 is disposed in the processing stage F of the bookbinding path 33. As shown in FIG. 4A, the coversheet binding means 60 is composed of a spine support plate 61, spine folding plates 62, and folding rollers 63. The coversheet conveyance path 34 described above is disposed in the processing stage F, and conveys a coversheet Sh from the image-forming unit A or the inserter unit 26. The spine support plate 61 is composed of a plate-shaped member that backs-up the coversheet Sh and is able to advance into and retract from the bookbinding path 33. The inner leaves of the sheet bundle Sn is joined in an upside-down T-shape to the coversheet Sh supported on the spine support plate 61. The spine folding plates 62 are composed of a pair of left and right side pressing members. These are composed to come together and separate by drive means, not shown, to fold and form the backside of the coversheet joined in an upside-down T-shape. The folding rollers 63 are composed of a pair of rollers that finish the cover by sandwiching the sheet bundle joined to the coversheet.

### Configuration of Bookmarker-String Supply Means

A feature of the present invention is to supply and set a bookmarker string 84 over the coversheet Sh fed and set at the processing stage F, and to bind the sheet bundle Sn to the coversheet Sh in that state. Bookmarker string supply means 80 is provided in the processing stage F to supply the bookmarker string 84 along with the coversheet Sh.

FIG. 5A shows one embodiment of the bookmarker string supply means 80. The bookmarker string supply means 80 shown in the drawing is composed of a cartridge (hereinafter referred to as a bookmarker-string storage unit) 81 that stores the bookmarker string 84, and feeder means 85 that pulls out the bookmarker string 84 from the bookmarker-string storage unit 81. The bookmarker-string storage unit 81 is detachably installed to the apparatus frame to be replaced; the bookmarker-string storage unit 81 is formed to a container-shape to internally store a plurality of bookmarker strings of a predetermined length in a bundle-shape. The bookmarker-string storage unit 81 in the drawing stores a roll-shaped bookmarker string 84. The roll-shaped bookmarker string 84 is stored so that its leading end projects outside from a supply opening 81a. The feeder means 85 that pulls out the bookmarker string 84 from the bookmarker-string storage unit 81 is composed of a sliding member 86 that pulls the string leading end 84a to the spine surface (indicated by the diagonal lines in FIG. 6B) coversheet Sh, and a rocking lever 87 that places a string trailing end 84b in a central portion of the coversheet Sh. A cutter 88 is disposed in the supply opening 81a of the bookmarker-string storage unit 81 to cut the string trailing end.

The sliding member 86 is movably supported on a guide rail 86g to move along a side edge of the coversheet Sh fed to and set at the processing stage F; the sliding member 86 reciprocates in the left and right directions of FIGS. 5A and 5B along the guide rail 86g. For this reason, this sliding member 86 is connected to a traveling wire 86w stretched along the guide rail 86g; a drive motor MM1 is connected to a pulley on one side that supports the traveling wire 86w.

Nipping claws 86n that grip a leading end of the bookmarker string 84 and an actuating solenoid 86S of the nipping claws 86n are installed in the sliding member 86. The nipping claws 86n pull the string leading end 84a of the bookmarker string 84 out from the bookmarker-string storage unit 81. The drawing shows the pair of claw members urged in a nipping direction by a wound spring 86b, and released by the actuating solenoid 86S.

The sliding member 86 pulls the leading end 84a of the bookmarker string 84 from the bookmarker-string storage unit 81 along the side edge (X-X in FIG. 5B) of the coversheet Sh set at the processing stage F. The rocking lever 87 moves the trailing end 84b of the bookmarker string 84 pulled in the X-X direction in a Y-Y that is perpendicular to the end, and moves to the center portion of the coversheet Sh. For that reason, the rocking lever 87 is disposed on the apparatus frame (not shown) to rock around the base portion 87a, and a rocking pin 87P is implanted in the leading end 87b to engage the bookmarker string 84.

A rocking motor MM2 is connected to the base portion 87a of the rocking lever 87. Therefore, the string trailing end 84b of the bookmarker string 84 pulled in the side edge (X-X) direction of the coversheet Sh, is pulled to the inner surface of the coversheet Sh with the drive of the rocking motor MM2, while the string leading end 84a is disposed at the spine binding surface (the oblique lines in FIG. 6B). The cutter 88 is disposed in the supply opening 81a of the bookmarker-string storage unit 81 to cut the bookmarker string 84 trailing end 84b. The cutter 88 cuts the string trailing end with the action of the solenoid 88S.

Actions of the bookmarker string supply means 80 will now be explained. FIG. 5A shows the coversheet Sh set at the processing stage F. The sliding member 86 is positioned at the supply opening 81a of the bookmarker-string storage unit 81 and the nipping claws 86n are placed in a state (its home position) to nip the leading end of the bookmarker string 84. The control CPU 75, described in detail below, receives the coversheet feed and set signals to rotatingly drive the drive motor MM1. This causes the sliding member 86 to move from the state shown in FIG. 5A to the state shown in FIG. 5B, and the bookmarker string 84 moves in the X-X direction along a side edge of the coversheet Sh.

Next, the control CPU 75 stops the drive motor MM1 when the sliding member 86 has moved to a predetermined position after a signal is received from a position sensor, not shown. The leading end of the bookmarker string 84 is set to be positioned at the spine binding surface of the coversheet Sh. The control CPU 75 then rotates the rocking motor MM2. Then, the rocking lever 87 positioned at its home position shown in FIG. 5A rotates in a clockwise direction in the state shown in FIG. 6A and the rocking pin 87P on the leading end of the lever moves the bookmarker string 84 in the Y-Y direction to the inner surface side of the coversheet Sh (the state shown in FIG. 6A). This positions the leading end 84a of the bookmarker string 84 at the spine binding surface of the coversheet Sh. With the trailing end positioned at the inner surface of the coversheet Sh, action from the solenoid 88S of the cutter 88 cuts the trailing end of the bookmarker string 84.

The control CPU 75 then applies adhesive to the inner-bound sheets of the sheet bundle Sn with the bookmarker string 84 laying over the coversheet Sh. When the adhesive has been applied to the inner-bound sheets of the sheet bundle Sn, the control CPU 75 joins the inner-bound sheets of the sheet bundle Sn to the spine binding portion of the coversheet Sh. After these are joined, the folding plates fold the coversheet Sh to form the shoulders of the booklet. The details of folding the coversheet Sh to form the shoulders have been explained above, but at the point where the folding operation ends, the control CPU 75 turns ON the actuating solenoid 86S of the nipping claws 86n to release the leading end 84a of the bookmarker string 84 and returns the sliding member 86 to its home position shown in FIG. 5A. The sliding member 86 returned to its home position nips a string leading end 84a of the bookmarker string 84 stored in the bookmarker-string storage unit 81 when the actuating solenoid 86S is turned OFF.

### Alternative Embodiment of Bookmarker-String Supply Means

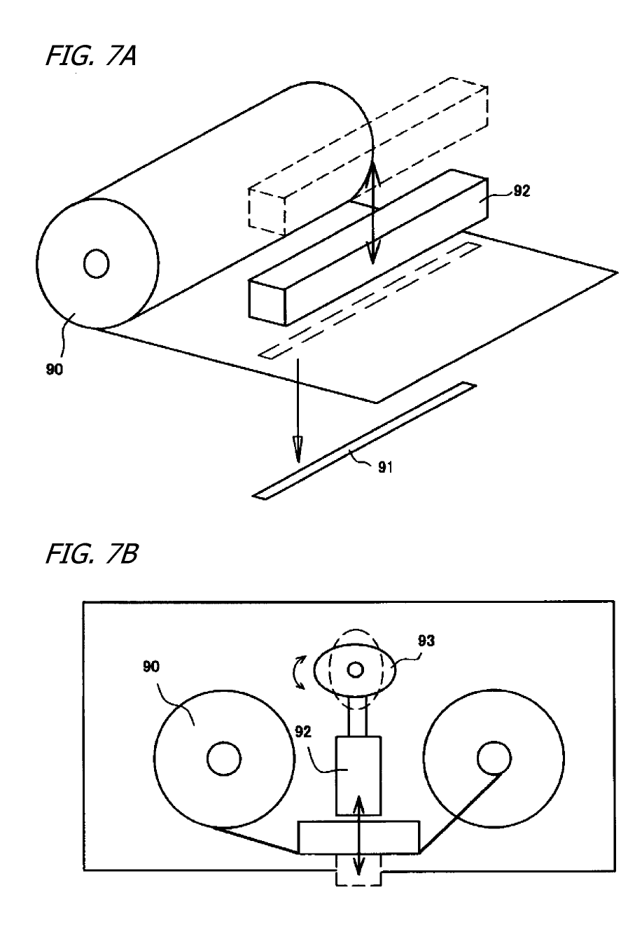

An embodiment was explained above where the bookmarker string supply means 80 stores bookmarker string 84 in a roll-shape or string bundle in the bookmarker-string storage unit 81, and after the coversheet Sh is fed to and set at the processing stage F, the bookmarker string 84 is placed over the spine binding portion of the coversheet Sh. It is also possible to adopt the configuration shown in FIG. 7 for the bookmarker string supply means 80.

The embodiment shown in the drawings is a device that creates a bookmarker string 91 from a base material 90 such as a film material for a bookmarker. The bookmarker base material 90, made of a material such as synthetic resin or cloth, is formed into the bookmarker string 91 using a forming die (forming means) 92. For that reason, the forming die 92 is supported on the apparatus frame to move up and down with regard to the bookmaker base material 90; the die is move up and down by the action of a drive cam 93. The bookmarker string 91 created by the pressing action of the forming die 92 is placed over the coversheet Sh in the same way as that described in relation to the former embodiment, by a feeder means, not shown. In other words, a structure is adopted that nips the bookmarker string 91 created by the forming die 92 and conveys the leading end to position it on the spine binding surface of the coversheet.

Note that the leading end 84a and trailing end 84b (in the same way as the bookmarker string 91) of the bookmarker string 84 are placed over the coversheet Sh at the processing stage F to project outward from the top (or bottom) of the sheet bundle Sn with the shoulders formed. It is possible to improve the quality of the finished booklet by trimming the leading end (or trailing end) of the string projecting outward when trimming true the side edges.

### Configuration of Bundle-Posture Changing Means

The following will now explain the finishing process for the sheet bundle formed into a booklet. The finishing process trims three side edges of the sheet bundle in booklet form excluding the spine portion. A bundle posture changing means 64 that turns the sheet bundle over from top to bottom, and trimming means 65 that cuts the edges of the sheet bundle are disposed in the trimming position G positioned downstream of the folding rollers 63. The bundle posture changing means 64 turns the covered sheet bundle fed from the coversheet binding location E to a predetermined direction (or orientation) and conveys the sheet bundle to the downstream trimming means 65 or to the storage stacker 67. The trimming means 65 trims the fringes of the sheet bundle to align the edges. Therefore, the bundle posture changing means 64 is equipped with rotating tables 64a, 64b that grip and turn the sheet bundle fed from the folding rollers 63. As shown in FIG. 2, the rotating tables 64a, 64b are established on the unit frame 64X installed on the apparatus frame to rise and lower. The pair of rotating tables 64a, 64b that sandwich the bookbinding path 33 are rotatably supported on bearings in the unit frame 64x; one of the movable rotating tables 64b supported to move in a sheet bundle thickness direction (a direction orthogonal to the bookbinding path 33). Turning motors, not shown, are furnished in the bookbinding path 33 for the rotating tables 64a, 64b to change the posture (or orientation) of the sheet bundle.

### Configuration of Trimming Means

Trimming means 65 is provided downstream of the bundle posture changing means 64. As shown in FIG. 2, the trimming means 65 is composed of a trimming edge pressing member 65b that pressingly supports the edge of the sheet bundle to be trimmed against a blade-edge bearing member 65a, and a trimming blade unit 65c. The trimming edge pressing member 65b is disposed in a position that opposes the blade-edge bearing member 65a disposed in the bookbinding path 33, and is composed of a pressing member that moves in an orthogonal direction to the sheet bundle by drive means, not shown. The trimming blade unit 65c is composed of a flat, blade-shaped trimming blade 65x and a cutter motor Mc that drives that blade. The trimming means 65 with this configuration cuts a predetermined amount around the edges, excluding the spine of the sheet bundle that has been made into a booklet, to align the edges.

A discharge roller (discharge means) 66 and storage stacker 67 are disposed downstream of the trimming position G. This storage stacker 67 stores sheet bundles in an inverted manner as shown in FIG. 2. This storage stacker 67 is disposed to be drawn from the casing 30 as shown in FIG. 1. The stacker can be drawing toward the front side of the apparatus (the front side of the sheet in FIG. 1). The operator can view it from the top direction when it is drawn to the front of the apparatus. Note that 67Sf in the drawing denotes a full detection sensor. This detects when the storage stacker 67 is at full capacity with sheet bundles stacked therein and issues a warning to the operator to remove the sheet bundles.

### Finisher Configuration

The finishing unit C is arranged in the bookbinding unit B. The finishing path 38 is equipped to be connected to coversheet conveyance path 34 for the finishing unit C and a finisher, such as a staple unit, punch unit, and stamp unit or the like, is disposed in the finishing path 38. Printed sheets are received from the image-forming unit A via the coversheet conveyance path 34 and stapled, punched or applied with a mark, then conveyed to the discharge tray 37. It is also possible not to apply any finishing process on printed sheets and to store them in the discharge tray 37 directly from the image-forming unit A.

### Configuration of Control Means

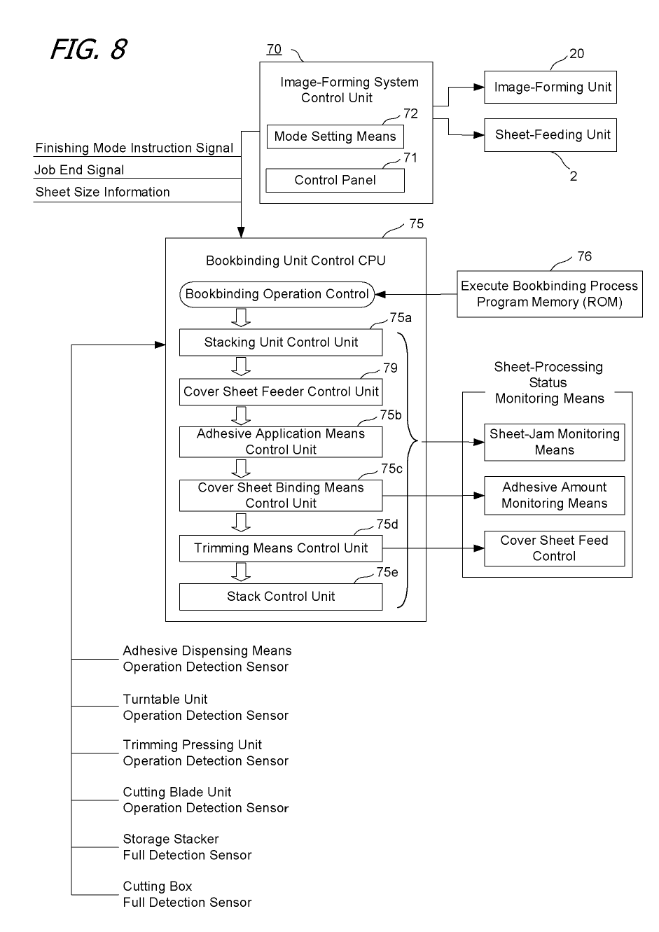

The configuration of the control means in the apparatus described above will now be explained with reference to FIG. 8. FIG. 8 is a control block diagram. As shown in FIG. 1, in the system that connects the image forming unit A and the bookmaking unit B, the control panel 71 and mode setting means 72 are connected to the control CPU70 provided on the image-forming unit A. A control CPU 75 is equipped in the control unit of the bookbinding unit B. This control CPU 75 calls up a bookbinding execution program from the ROM76 and executes each process in the bookbinding path 33.

This control CPU 75 receives a finishing mode instruction signal, job end signal, sheet size information, and other information and command signals required in the bookbinding process from the control CPU70 of the image-forming unit A. On the other hand, sheet sensors Se1 to Se6 are arranged in the positions shown in FIG. 2 to detect the sheets (sheet bundle) conveyed to the conveyance path 31, bookbinding path 33, and coversheet conveyance path 34. Detection signals from the sheet sensors Se1 to Se6 are transmitted to the control CPU 75; the control CPU 75 is equipped with “stacking unit control unit 75a,” “adhesive application means control unit 75b,” “coversheet binding means control unit 75c,” “trimming means control unit 75d,” “stack control unit 75e,” and “adhesive temperature control unit 79.”

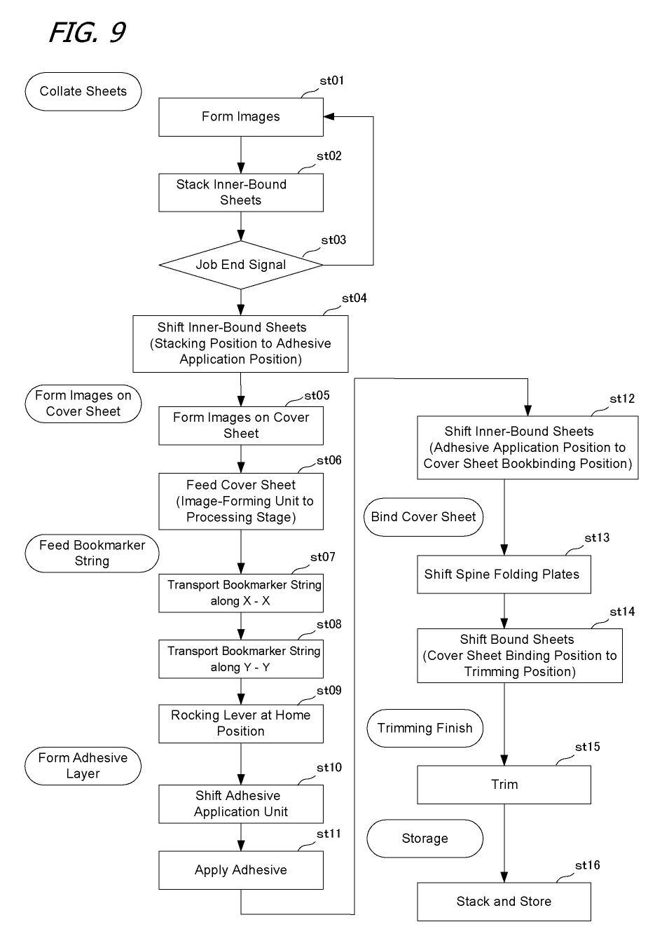

Next, to explain the bookbinding method according to the present invention, one feature of the present invention is to also glue the bookmarker string 84 to the spine portion at the same time as binding the inner-bound sheets of the sheet bundle to the coversheet. That bookbinding method will now be explained based on the flowchart shown in FIG. 9.

When the finishing mode and image-forming mode are set on the image-forming unit A, the image-forming unit A sequentially forms images on the sheets and discharges the sheets to the discharge outlet 14 (St01). The sheets (inner-bound sheets Sn) conveyed out to the discharge outlet 14 of the image-forming unit A are conveyed from the sheet conveyance in path 31 to the bookbinding unit B. When the system is set to “bookmaking process mode,” the control CPU 75 of the bookbinding unit guides the inner-bound sheets of the sheet bundle Sn to the stacking tray 41 and stacks them there. (St02) When a job end signal is received from the image-forming unit A, the control CPU 75 moves the stacking tray 41 downward, in FIG. 2, to hand-over the sheet bundle on the tray to the gripping conveyance means 47. The gripping conveyance means 47 turns substantially 90° so that the spine edge portion of the sheet bundle is downward, and moves that sheet bundle in that orientation to the adhesive application location in the bookbinding path 33 (St04). Next, an image is printed onto the coversheet specified at the image-forming unit A, and then the sheet is conveyed out from the discharge outlet 14. The coversheet is received in the sheet conveyance in path 31 at the bookbinding unit B, and guided to the coversheet conveyance path 34 via a path switching flapper 36. The coversheet is conveyed and set at the processing stage F after it is registered and skewing has been corrected at the path 34 (St06).

The sheet bundle thickness detection means (not shown) is provided on the gripping conveyance means 47; coversheets are positioned and set at the processing stage F based on the sheet bundle thickness information obtained from the detection means. The control CPU 75 moves the sliding member 86 along the rail 86g. Then, the bookmarker string 84 gripped by the nipping claws 86n of the sliding member 86 is pulled a predetermined amount from the bookmarker-string storage unit 81. Next, the control CPU 75 rotatingly drives the rocking motor MM2 that rotates the rocking lever 87 in the clockwise direction (see FIGS. 5A and 5B). Then, the string trailing end of the bookmarker string 84 pulled out along the edge of the bookmarker string 84 is moved in the Y-Y direction by the rocking pin 87P of the leading end of the rocking lever and placed over the coversheet Sh (St08). The cutter 88 cuts the trailing end of the bookmarker string 84. Then, the rocking lever 87 returns to its home position (St09).

When the bookmarker string 84 is laid over the coversheet Sh, the control CPU 75 moves the adhesive application means 55 along the spine portion surface of the inner-bound sheets of the sheet bundle to coat the sheets with adhesive (St11). Then, the control CPU 75 moves the inner-bound sheets of the sheet bundle Sn from the adhesive application location E to the coversheet binding location F (St12). At this time, the spine support plate 61 is held in a position that backs up the coversheet Sh so that the coversheet Sh and inner-bound sheets of the sheet bundle are joined in an upside-down T shape. In this state, the folding plates 62 press the shoulder portions of the coversheet Sh with the drive motor, not shown (St13). After the shoulders have been formed, the control CPU 75 retreats the spine support plate 61 from the bookbinding path 33 after a predetermined amount of time has passed for the adhesive to harden. The coversheet of the bound sheet bundle is folded by the folding rollers 63 and the sheet bundle is then conveyed to the downstream trimming position G. At the trimming position G, the cutting means 65 trims true the edges of the sheet bundle while the sheet bundle posture changing means 64 turns the sheet bundle in order from the top, the bottom and the fore-edge (St15). Next, the control CPU 75 stores this trimmed sheet bundle in the storage stacker 67 (St16).

The bookbinding method according to the present invention executes a coversheet feeding step (step St06) that conveys a coversheet to a predetermined coversheet binding location; a bookmarker string setting step that places a bookmarker string over a predetermined position on the coversheet conveyed to the coversheet binding location (steps St07, St08); an adhesive layer forming step that applies a layer of adhesive on a spine portion of inner-bound sheets collated into a bundle shape (step St11); and a coversheet binding step that binds the inner-bound sheets of the sheet bundle to the coversheet overlapped with the bookmarker string (step St14).

The present application claims priority from Japanese Pat. App. No. 2007-235952, which is herein incorporated by reference.

What is claimed is:

1. A bookbinding unit furnished with a processing stage where inner-bound sheets collated into bundle form are encased in a coversheet, the bookbinding unit comprising:
adhesive-layer formation means, disposed upstream of the processing stage, for coating a layer of adhesive onto a spine-portion endface of the inner-bound sheets;
coversheet feeding means for feeding coversheets to the processing stage;
bookmarker-string supplying means for feeding a bookmarker string into position onto a coversheet fed to the processing stage;
coversheet binding means, disposed in the processing stage, for spine-creasing a coversheet to mold it onto inner-bound sheets; and
control means for controlling said coversheet feeding means, said bookmarker-string supplying means, and said coversheet binding means;
wherein said control means is configured to
(i) supply coversheets to the processing stage,
(ii) supply a bookmarker string onto a coversheet in the processing stage, and
(iii) form spine creases in the coversheet after joining together the bookmarker string, the inner-bound sheets, and the coversheet.

2. The bookbinding unit according to claim 1, said bookmarker-string supplying means comprising:
a bookmarker-string storage unit; and
feeder means for feeding a bookmarker string from the bookmarker-string storage unit to a spine-binding portion of a coversheet; wherein
the bookmarker-string storage unit is configured to store a continuous roll of string, or a string spool of predetermined length.

3. The bookbinding unit according to claim 1, wherein the bookmarker-string supplying means comprises:
a textile, plastic-film, or other base material;
forming means for punching out bookmarker strings of a predetermined shape from the bookmarker base material; and
feeder means for feeding a bookmarker string from the forming means to the spine-binding portion of a coversheet.

4. The bookbinding unit according to claim 1, further comprising trimming means, downstream of the processing stage, for trimming true the peripheral edges of a coversheet-binding-processed sheet bundle; wherein:
the trimming means when trimming a sheet bundle cuts off the end edge of the bookmarker string.

5. An image-forming system comprising:
an image-forming unit for sequentially forming images onto sheets; and
a bookbinding unit for collating into bundles sheets conveyed from the image-forming unit, and encasing the bundles in coversheets; wherein
the bookbinding apparatus is furnished with the configuration recited in claim 1.

6. An image-forming system comprising:
an image-forming unit for sequentially forming images onto sheets; and
a bookbinding unit for collating into bundles sheets conveyed from the image-forming unit, and encasing the bundles in coversheets; wherein
the bookbinding apparatus is furnished with the configuration recited in claim 2.

7. An image-forming system comprising:
an image-forming unit for sequentially forming images onto sheets; and
a bookbinding unit for collating into bundles sheets conveyed from the image-forming unit, and encasing the bundles in coversheets; wherein
the bookbinding apparatus is furnished with the configuration recited in claim 3.

8. An image-forming system according to claim 4 comprising:
an image-forming unit for sequentially forming images onto sheets; and
a bookbinding unit for collating into bundles sheets conveyed from the image-forming unit, and encasing the bundles in coversheets; wherein
the bookbinding apparatus is furnished with the configuration recited in claim 4.

9. An image forming system furnished with an image forming means for forming images onto sheets, stacking means for collating and stacking sheets from said image-forming means, and a processing stage where inner-bound sheets collated by said stacking means are encased in a coversheet, the image-forming system therein comprising:
adhesive-layer formation means, disposed upstream of the processing stage, for coating a layer of adhesive onto a spine-portion endface of the inner-bound sheets;
coversheet feeding means for feeding coversheets to the processing stage;
bookmarker-string supplying means for feeding a bookmarker string into position onto a coversheet fed to the processing stage;
coversheet binding means, disposed in the processing stage, for spine-creasing a coversheet to mold it onto inner-bound sheets; and
control means for controlling said coversheet feeding means, said bookmarker-string supplying means, and said coversheet binding means;
wherein said control means is configured to
(iv) supply coversheets to the processing stage,
(v) supply a bookmarker string onto a coversheet in the processing stage, and
(vi) form spine creases in the coversheet after joining together the bookmarker string, the inner-bound sheets, and the coversheet.

10. A bookbinding method whereby inner-bound sheets collated into bundle form are encased in a coversheet, the method comprising:
a step of feeding a coversheet to a predetermined coversheet binding location;
a bookmarker-string setting step of overlaying a bookmarker string in a predetermined position onto the coversheet fed to the coversheet binding location;
an adhesive-layer formation step of coating a layer of adhesive onto a spine-portion endface of the inner-bound sheets collated into a sheet bundle; and
a coversheet encasing step of binding the inner-bound sheets together with the coversheet onto which the bookmarker string has been overlaid.

11. The bookbinding method according to claim 10, wherein in said bookmarker-string setting step:
one end of the bookmarker string is positioned on a spine-binding portion of the coversheet, and the other end is overlaid onto the coversheet so as to be located on an inner surface of the coversheet.
